(19) United States
(12) Patent Application Publication
(10) Pub. No.: US 2010/0266772 A1
(43) Pub. Date: Oct. 21, 2010

(54) METHODS OF FORMING COATING SYSTEMS ON SUPERALLOY TURBINE AIRFOILS

(75) Inventor: Yiping Hu, Greer, SC (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/426,595

(22) Filed: Apr. 20, 2009

(51) Int. Cl. B05D 3/02

(52) U.S. Cl. 427/328; 427/383.7

(57) ABSTRACT

Methods are provided for forming coating systems on advanced single crystal superalloy turbine airfoils. A method includes applying a layer of an additive material onto a substrate, the additive material comprising a precious metal and the substrate comprising a nickel-based superalloy, diffusion heat treating the substrate to form an intermetallic coating which comprises γ-Ni and γ′-Ni₃Al phases alloyed with the additive material and one or more reactive elements from the substrate including hafnium, yttrium, chromium, and silicon, and finally depositing a thermal barrier coating over the intermetallic coating to form the coating system.

### TECHNICAL FIELD

The inventive subject matter generally relates to coatings on superalloy turbine airfoils, and more particularly relates to methods of forming coating systems on superalloy turbine airfoils.

### BACKGROUND

Turbine engines are used as the primary power source for various kinds of aircraft. Turbine engines may also serve as auxiliary power sources that drive air compressors, hydraulic pumps, and industrial electrical power generators. Most turbine engines generally follow the same basic power generation procedure. Specifically, compressed air is mixed with fuel and burned, and the expanding hot combustion gases are directed against stationary turbine vanes in the engine. The stationary turbine vanes turn the high velocity gas flow partially sideways to impinge onto turbine blades mounted on a rotatable turbine disk. The force of the impinging gas causes the turbine disk to spin at a high speed. Some turbine engines, such as jet propulsion engines, use the power created by the rotating turbine disk to draw more air into the engine, and the high velocity combustion gas is passed out of the turbine engine to create a forward thrust. Other engines use this power to turn one or more propellers, electrical generators, or other devices.

Because fuel efficiency increases as engine operating temperatures increase, turbine components such as engine blades and vanes are typically exposed to extremely hot gas temperatures, which may be, for example, greater than about 1150° C. In this regard, the turbine engine blades and vanes may be fabricated from high-temperature base materials such as advanced single crystal nickel-based superalloys. Although these superalloys have good elevated-temperature properties and many other advantages, they may be susceptible to corrosion, oxidation, thermal fatigue, and/or foreign particle impact when exposed to harsh working environments during turbine engine operation. Thus, the turbine engine blades and/or vanes may be coated with protective coatings, which have been developed to increase the operating temperature limits and prolong service lives of the turbine components.

One category of conventional coatings includes platinum aluminide coatings. Platinum aluminide coatings may serve as bond coats for bonding thermal barrier coatings to a turbine component. Specifically, because some thermal barrier coatings may be porous or columnar and may include small channels, hot air may permeate the thermal barrier coating through these small channels to the bond coat surface. Thus, aluminum from the platinum aluminide coating may react with the permeated oxygen in the air to form an interfacial, protective aluminum oxide (alumina) scale over the platinum aluminide coating. However, when platinum aluminide coatings are deposited over advanced “third” and “fourth” generations of single crystal superalloys, which typically include between 20% to 25%, by weight of refractory elements, such as Ta, W, Re, Ru and Mo, and then exposed to high temperatures, two major phases of the superalloy (e.g., gamma (γ-Ni) and gamma prime (γ′-Ni₃Al) phases) may no longer be in equilibrium with each other due to inter-diffusion between the coating and the underlying base alloy (forming an “interdiffusion zone”) as well as mismatch strains within the underlying base material. A cellular-shaped secondary reaction zone (SRZ) underneath the interdiffusion zone may also form. The SRZ may undesirably affect turbine airfoil performance, because it may deplete refractory elements, such as Re and W, from the gamma matrix due to formation of topologically close-packed (“TCP”) phases. As a result, the desirable elevated-temperature properties of the underlying superalloy may be reduced. Moreover, because TCP phases are typically needle-like in shape, they may increase potential crack initiation locations. Furthermore, the coating may spall off prematurely from the base material.

Various methods have been employed in attempts to prevent SRZ formation. For example, the methods have included subjecting the base alloy to special heat treatment processes, shot peening processes, insertion of transition layers between the base alloy and platinum aluminide coating, and carburization of the base alloy. However, these processes undesirably increase production costs.

Accordingly, it is desirable to have a turbine component coating that is improved over conventional platinum aluminide coatings. More particularly, it is desirable to have a turbine component coating system that may have improved adherence to a turbine component than conventional platinum aluminide/TBC coating system. In addition, it is desirable to provide methods of forming coatings that are more efficient, less expensive, and relatively simple to perform as compared to conventional coating formation methods. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Methods are provided for forming coating system on advanced single crystal superalloy turbine airfoils.

In an embodiment, by way of example only, a method includes applying a layer of an additive material over a substrate, the additive material comprising a precious metal and the substrate comprising a nickel-based superalloy including, by weight, about 9.3% to about 9.8% cobalt, about 6.5% to about 7.0% chromium, about 1.3% to about 1.7% molybdenum, about 3.8% to about 4.1% tungsten, about 2.4% to about 2.8% rhenium, about 5.8% to about 6.3% tantalum, about 6.0% to about 6.4% aluminum, about 1.1% to about 1.3% hafnium, about 0.08% to about 0.12% carbon, about 0.1% to about 0.5% silicon, about 0.008% to about 0.012% boron, about 0.01% to about 0.03% zirconium, about 0.006% to about 0.015% yttrium, and a balance of nickel, diffusion heat treating the substrate to form an intermetallic coating, the intermetallic coating comprising a γ-Ni phase and a γ′-Ni₃Al phase, each of the γ-Ni phase and the γ′-Ni₃Al phase alloyed with the additive material and one or more reactive elements from the substrate including hafnium, yttrium, chromium, and silicon, and depositing a thermal barrier coating over the intermetallic coating to form the coating system.

In another embodiment, by way of example only, a method includes applying a layer of an additive material over a substrate, the additive material comprising a precious metal and the substrate comprising a nickel-based superalloy including, by weight, about 9.8% to about 10.2% cobalt, about 5.2% to about 5.4% chromium, about 1.6% to about 1.8% molybdenum, about 4.8% to about 5.1% tungsten, about 2.8% to about 3.2% rhenium, about 7.5% to about 8.5% tantalum, about 5.0% to about 5.4% aluminum, about 0.9% to about 1.1% titanium, about 0.18% to about 0.50% hafnium, about 0.015% to about 0.02% carbon, about 0.1% to about 0.5% silicon, about 0.003% to about 0.005% boron, about 0.001% to about 0.0035% lanthanum, about 0.001% to about 0.0035% yttrium, and a balance of nickel, diffusion heat treating the substrate to form an intermetallic coating, the intermetallic coating comprising a γ-Ni phase and a γ′-Ni₃Al phase, each of the γ-Ni phase and the γ′-Ni₃Al phase alloyed with the additive material and one or more of reactive elements from the substrate including hafnium, yttrium, chromium, and silicon, and depositing a thermal barrier coating over the intermetallic coating to form the coating system.

In still another embodiment, by way of example only, a method includes applying a layer of an additive material over a substrate, the additive material comprising a precious metal and the substrate comprising a nickel-based superalloy including, by weight, about 9.3% to about 9.8% cobalt, about 6.3% to about 6.7% chromium, about 1.6% to about 2.0% molybdenum, about 5.4% to about 5.8% tungsten, about 2.8% to about 3.2% rhenium, about 6.8% to about 7.2% tantalum, about 6.1% to about 6.4% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, and a balance of nickel, diffusion heat treating the substrate to form an intermetallic coating, the intermetallic coating comprising a γ-Ni phase and a γ′-Ni₃Al phase, each of the γ-Ni phase and the γ′-Ni₃Al phase alloyed with the additive material and one or more reactive elements from the substrate including hafnium, yttrium, chromium, and silicon, and depositing a thermal barrier coating over the intermetallic coating to form the coating system.

In still another embodiment, by way of example only, a method includes applying a layer of an additive material over a substrate, the additive material comprising a precious metal and the substrate comprising a nickel-based superalloy including, by weight, about 10.0% to about 10.5% cobalt, about 3.8% to about 4.2% chromium, about 1.8% to about 2.2% molybdenum, about 4.8% to about 5.2% tungsten, about 5.8% to about 6.2% rhenium, about 5.8% to about 6.2% tantalum, about 5.5% to about 5.8% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, about 3.8% to about 4.2% ruthenium, and a balance of nickel, diffusion heat treating the substrate to form an intermetallic coating the intermetallic coating comprising a γ-Ni phase and a γ′-Ni₃Al phase, each of the γ-Ni phase and the γ′-Ni₃Al phase alloyed with the additive material and one or more reactive elements from the substrate including hafnium, yttrium, chromium, and silicon, and depositing a thermal barrier coating over of the intermetallic coating to form the coating system.

### BRIEF DESCRIPTION OF THE DRAWINGS

The inventive subject matter will hereinafter be described in conjunction with the following drawing figures, wherein like numerals denote like elements, and

FIG. 1 is a cross section of a portion of a component with a coating system, according to an embodiment; and

FIG. 2 is a flow diagram of a method of forming a coating system on a turbine component, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

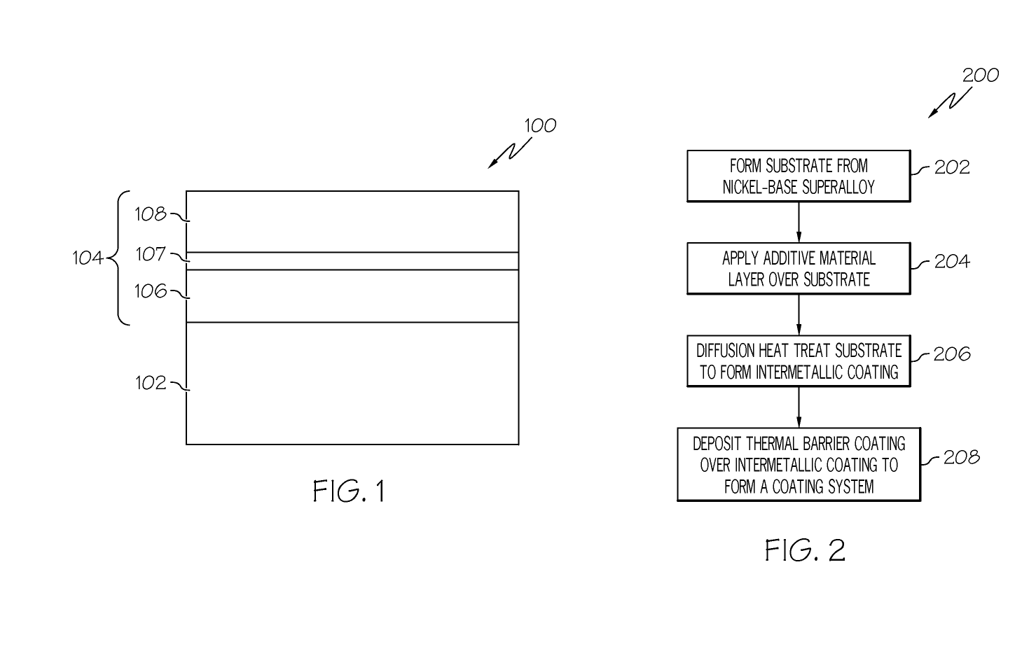

FIG. 1 is a cross section of a portion of a component 100, according to an embodiment. The component 100 may be a turbine engine component, such as a turbine blade or a nozzle guide vane airfoil, and the like and is configured to be oxidation and hot corrosion resistant when used in high temperature applications (e.g., a component operating in a harsh environment and subjecting to turbine inlet temperatures greater than about 1150° C.). In this regard, the component 100 may include a substrate 102 and a coating system 104 deposited over the substrate 102. The coating system 104 is configured to protect the substrate 102, and hence, the component 100, from high gas temperatures and/or oxidation. Specifically, when the coating system 104 is exposed to hot air, a thin (e.g., less than 6 microns) protective alumina scale may grow at a rate that is slower than a rate at which an oxide scale would grow on a conventionally-coated substrate. The slowed alumina scale growth may improve adhesion of the thermal barrier coating 108 to the intermetallic coating 106. In this regard, in an embodiment, the coating system 104 comprises four components, namely, a portion of the substrate 102, an intermetallic coating 106, a thermally grown oxide (TGO) 107, and a thermal barrier coating 108. The four components are specifically formulated to interact with each other during coating formation to produce a resultant coating capable of providing a particular degree of protection to the substrate 102.

In an embodiment, the substrate 102 comprises a nickel-based superalloy that includes a predetermined balance of alloying elements, such as nickel and aluminum, one or more reactive elements, and other constituents. As used herein, the term “alloying element” may be defined as an element that forms a gamma matrix and/or gamma prime phases of the superalloy (eg., γ-Ni and γ′-Ni₃Al phases). The term “reactive element” may be defined as an element that is capable of migrating from the substrate 102 into intermetallic coating 106 or a thin layer (e.g., less than 6 microns) of aluminum oxide, also referred to herein as the TGO 107, over the intermetallic coating 106 when the coating system 104 is exposed to hot air. The particular quantities of the one or more reactive elements and other constituents and the balance between the particular quantities are designed such that the nickel-based superalloy is capable of maintaining structural integrity when exposed to a particular thermal environment or other impact from foreign particles. Additionally, the designed quantities allow migration of at least a portion of the one or more reactive elements out of the substrate 102 during formation of the intermetallic coating 106 of the coating system 104.

In an embodiment, the coating system 104 may employ a nickel-based superalloy that includes, by weight, about 9.3% to about 9.8% cobalt, about 6.5% to about 7.0% chromium, about 1.3% to about 1.7% molybdenum, about 3.8% to about 4.1% tungsten, about 2.4% to about 2.8% rhenium, about 5.8% to about 6.3% tantalum, about 6.0% to about 6.4% aluminum, about 1.1% to about 1.3% hafnium, about 0.08% to about 0.12% carbon, about 0.1% to about 0.5% silicon, about 0.008% to about 0.012% boron, about 0.01% to about 0.03% zirconium, about 0.006% to about 0.015% yttrium, and a balance of nickel. In another embodiment, the coating system 104 may employ a nickel-based superalloy that includes by weight, about 9.8% to about 10.2% cobalt, about 5.2% to about 5.4% chromium, about 1.6% to about 1.8% molybdenum, about 4.8% to about 5.1% tungsten, about 2.8% to about 3.2% rhenium, about 7.5% to about 8.5% tantalum, about 5.0% to about 5.4% aluminum, about 0.9% to about 1.1% titanium, about 0.18% to about 0.50% hafnium, about 0.015% to about 0.02% carbon, about 0.1% to about 0.5% silicon, about 0.003% to about 0.005% boron, about 0.001% to about 0.0035% lanthanum, about 0.001% to about 0.0035% yttrium, and a balance of nickel. In still another embodiment, the coating system 104 may employ a nickel-based superalloy that includes, by weight, about 9.3% to about 9.8% cobalt, about 6.3% to about 6.7% chromium, about 1.6% to about 2.0% molybdenum, about 5.4% to about 5.8% tungsten, about 2.8% to about 3.2% rhenium, about 6.8% to about 7.2% tantalum, about 6.1% to about 6.4% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, and a balance of nickel. In still another embodiment, the coating system 104 may employ a nickel-based superalloy that includes, by weight, about 10.0% to about 10.5% cobalt, about 3.8% to about 4.2% chromium, about 1.8% to about 2.2% molybdenum, about 4.8% to about 5.2% tungsten, about 5.8% to about 6.2% rhenium, about 5.8% to about 6.2% tantalum, about 5.5% to about 5.8% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, about 3.8% to about 4.2% ruthenium, and a balance of nickel. Sulfur is preferably controlled to a weight percentage of within 0.0001 weight %. In one or more of the nickel-based superalloy compositions described above, some impurities, such as iron, niobium, vanadium, zirconium, copper, phosphorus, manganese, magnesium, and silver may be included.

The intermetallic coating 106 is formed from an additive material and from one or more alloying elements and reactive elements that are inherent in the substrate 102. Although the intermetallic coating 106 employs the elements inherent in the substrate 102, an interface between the intermetallic coating 106 and the substrate 102 may remain distinct, in an embodiment. Furthermore, the intermetallic coating 106 may have a graded composition that includes a substantially equal amount of the alloying and/or reactive elements at locations adjacent to the substrate 102 and a greater amount of the additive materials at locations located outwardly relative to the substrate 102. As a result of the particular design of the intermetallic coating 106, undesirable results, such as inward migration of atoms of aluminum or outward diffusion of the atoms during exposure to engine operating conditions may be minimized or may not occur at all. Hence, phase change of the elements in the intermetallic coating 106 may be avoided and the thermal barrier coating 108 may remain adhered to the substrate 102 longer during engine operation.

In an embodiment, the additive material of the intermetallic coating 106 comprises a precious metal, such as palladium, platinum, ruthenium, and the like. In another embodiment, the additive material includes platinum, and the reactive elements include hafnium, and yttrium. In another embodiment, the additive material includes platinum, and the reactive elements include hafnium, yttrium, and silicon. In still another embodiment, the additive material includes platinum, and the reactive elements include hafnium, yttrium, silicon, and chromium. In still another embodiment, the additive material includes platinum, and the reactive elements include hafnium, yttrium, silicon, chromium, and lanthanum. In accordance with an embodiment of the intermetallic coating 106, the additive material and reactive elements may be present, by weight as follows: Pt in a range of about 10% to about 35%, Hf in a range of about 0.18% to about 0.50%, Cr in a range of about 4.0% to about 7.0%, Si in a range of about 0.1% to about 0.5%, Y in a range of about 0.001% to about 0.0035% and La in a range of about 0.001% to about 0.0035%. In an embodiment, the intermetallic coating 106 may have a thickness in a range of from about 20 μm (microns) to about 40 μm. In another embodiment, the thickness of the intermetallic coating 106 may be greater or less than the aforementioned range.

The thermal barrier coating 108 is formed over a surface of the intermetallic coating 106 and may comprise a ceramic or a ceramic composite. In another embodiment, the thermal barrier coating 108 may comprise about 7 weight % yttria-stabilized zirconia. In still other embodiments, the thermal barrier coating 108 may comprise yttria stabilized zirconia doped with other oxides, such as Gd₂O₃, TiO₂, and the like. In still other embodiments, other suitable materials for use as thermal barrier coatings may alternatively be employed. In an embodiment, the thermal barrier coating 108 may have a thickness in a range of from about 50 μm to about 250 μm. In another embodiment, the thickness of the thermal barrier coating 108 may be greater or less than the aforementioned range. In any case, the TGO 107 forms between the intermetallic coating 106 and the thermal barrier coating 108.

FIG. 2 is a flow diagram of a method 200 of forming a coating system 104 on a component, according to an embodiment. In an embodiment, the method 200 includes forming a turbine airfoil from a nickel-based superalloy, step 202. The nickel-based superalloy may have a formulation that is substantially similar to that of the substrate 102 described above. Next, a layer of an additive material is applied over the substrate, step 204. In an embodiment, the additive material may include a precious metal, such as platinum, palladium, or ruthenium. In another embodiment, the additive material comprises pure platinum. As used herein, the term “pure platinum” may be defined as platinum having a purity of greater than about 99%. In accordance with an embodiment, the layer of additive material is applied directly to the surface of the substrate. The layer of additive material may be applied to the substrate by a plating process. For example, electroplating, electroless plating or other plating processes may be employed. In another embodiment, the layer of additive material may be deposited by a deposition process, such as by laser deposition, and the like. In still another embodiment, the layer of additive material may be applied to the substrate by a sputtering process. In any case, the layer of additive material may be applied to a thickness in a range of from about 6 μm to about 14 μm, in an embodiment. In another embodiment, the layer of additive material may be thicker or thinner than the aforementioned range.

The substrate is diffusion heat treated to form an intermetallic coating (e.g., intermetallic coating 106) comprising γ-Ni and γ′-Ni₃Al phases, where the phases are alloyed with the additive material and the reactive elements from the substrate, step 206. The intermetallic coating may include a composition that is substantially similar to those described above in relation to intermetallic coating 106 (FIG. 1). In order to diffuse the desired quantity of reactive elements from the substrate into the layer of additive material to form the intermetallic coating, the substrate may be disposed in a vacuum furnace and subjected to heat treatment at temperatures in a range of from about 1093° C. to about 1177° C. for a time period of about 1 hour to about 4 hours. In other embodiments, the diffusion heat treatment may occur at a temperature and/or for a duration outside of the aforementioned ranges. Unlike conventional platinum aluminide coating formation processes in which an aluminizing step (e.g., deposition of an aluminum layer and diffusion heat treatment thereof) is included, aluminum is inherently in the superalloy substrate and interacts with the additive materials to form the intermetallic coating using the above-described embodiment. As a result, no aluminizing step is needed.

A thermal barrier coating (e.g., coating 108) is deposited over the intermetallic coating to form the coating system, step 208. Because the aluminizing step is omitted, the thermal barrier coating may be deposited directly over the intermetallic coating. The thermal barrier coating may comprise a ceramic or a ceramic composite, such as a material mentioned above in relation to thermal barrier coating 108. The thermal barrier coating may be applied by a deposition process, such as by electron beam physical vapor deposition (EB-PVD), and plasma spraying or another suitable deposition or application process. In an embodiment, the thermal barrier coating may be deposited to a thickness in a range from about 50 μm to about 300 μm. In other embodiments, the thickness of the thermal barrier coating may be in a range of from about 100 μm to about 250 μm. In still other embodiments, the thermal barrier coating may be thicker or thinner than the aforementioned ranges.

By applying the above-mentioned materials in the manner described above, a complete coating system that may be improved over conventional platinum aluminide/TBC coating systems is provided over a substrate. Unlike conventional coatings, where each layer of the coating materials is typically separately deposited to form homogenized coating system after multi-step diffusion heat treatments to provide a protective property to a substrate, the above-described coating system incorporates the particular composition of the substrate for forming an intermetallic coating, which is specifically designed to prevent the secondary reaction zone formation and improve adherence of the thermal barrier coating to the substrate. Moreover, the above-described methods of forming the coating system may be more efficient, less expensive, and relatively simple to perform as compared to conventional coating formation methods.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of forming a coating system, the method comprising the steps of:
applying a layer of an additive material over a substrate, the additive material comprising a precious metal, and the substrate comprising a nickel-based superalloy including, by weight, about 9.3% to about 9.8% cobalt, about 6.5% to about 7.0% chromium, about 1.3% to about 1.7% molybdenum, about 3.8% to about 4.1% tungsten, about 2.4% to about 2.8% rhenium, about 5.8% to about 6.3% tantalum, about 6.0% to about 6.4% aluminum, about 1.1% to about 1.3% hafnium, about 0.08% to about 0.12% carbon, about 0.1% to about 0.5% silicon, about 0.008% to about 0.012% boron, about 0.01% to about 0.03% zirconium, about 0.006% to about 0.015% yttrium, and a balance of nickel;
diffusion heat treating the substrate to form an intermetallic coating, the intermetallic coating comprising a γ-Ni phase and γ′-Ni₃Al phase, each of the γ-Ni phase and the γ′-Ni₃Al phase alloyed with the additive material and one or more reactive elements from the substrate including hafnium, yttrium, chromium, and silicon; and
depositing a thermal barrier coating over the intermetallic coating to form the coating system.

2. The method of claim 1, wherein the step of applying the layer of the additive material comprises plating the layer of the additive material directly onto the substrate.

3. The method of claim 1, wherein the additive material consists essentially of pure platinum.

4. The method of claim 1, wherein the step of depositing the thermal barrier coating comprises depositing the thermal barrier coating directly on top of the intermetallic coating.

5. The method of claim 1, wherein the step of diffusion heat treating comprises heating the substrate to a temperature in a range of from about 1093° C. to about 1177° C. for a time period in a range of from about 1 hour to about 4 hours.

6. A method of forming a coating system, the method comprising the steps of:
applying a layer of an additive material over a substrate, the additive material comprising a precious metal, and the substrate comprising a nickel-based superalloy including, by weight, about 9.8% to about 10.2% cobalt, about 5.2% to about 5.4% chromium, about 1.6% to about 1.8% molybdenum, about 4.8% to about 5.1% tungsten, about 2.8% to about 3.2% rhenium, about 7.5% to about 8.5% tantalum, about 5.0% to about 5.4% aluminum, about 0.9% to about 1.1% titanium, about 0.18% to about 0.50% hafnium, about 0.015% to about 0.02% carbon, about 0.1% to about 0.5% silicon, about 0.003% to about 0.005% boron, about 0.001% to about 0.0035% lanthanum, about 0.001% to about 0.0035% yttrium, and a balance of nickel;
diffusion heat treating the substrate to form an intermetallic coating, the intermetallic coating comprising a γ-Ni phase and a γ′-Ni₃Al, each of the γ-Ni phase and the γ′-Ni₃Al phase alloyed with the additive material and one or more of reactive elements from the substrate including hafnium, yttrium, chromium, and silicon; and
depositing a thermal barrier coating over the intermetallic coating to form the coating system.

7. The method of claim 6, wherein the step of applying the layer of the additive material comprises plating the layer of the additive material directly onto the substrate.

8. The method of claim 6, wherein the additive material consists essentially of pure platinum.

9. The method of claim 6, wherein the step of depositing the thermal barrier coating comprises depositing the thermal barrier coating directly on top of the intermetallic coating.

10. The method of claim 6, wherein the step of diffusion heat treating comprises heating the substrate to a temperature in a range of from about 1093° C. to about 1177° C. for a time period in a range of from about 1 hour to about 4 hours.

11. A method of forming a coating system, the method comprising the steps of:
applying a layer of an additive material over a substrate, the additive material comprising a precious metal, and the substrate comprising a nickel-based superalloy including, by weight, about 9.3% to about 9.8% cobalt, about 6.3% to about 6.7% chromium, about 1.6% to about 2.0% molybdenum, about 5.4% to about 5.8% tungsten, about 2.8% to about 3.2% rhenium, about 6.8% to about 7.2% tantalum, about 6.1% to about 6.4% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, and a balance of nickel;
diffusion heat treating the substrate to form an intermetallic coating, the intermetallic coating comprising a γ-Ni phase and a γ′-Ni₃Al phase, each of the γ-Ni phase and the γ′-Ni₃Al phase alloyed with the additive material and one or more reactive elements from the substrate including hafnium, yttrium, chromium, and silicon; and
depositing a thermal barrier coating over the intermetallic coating to form the coating system.

12. The method of claim 11, wherein the step of applying the layer of the additive material comprises plating the layer of the additive material directly onto the substrate.

13. The method of claim 11, wherein the additive material consists essentially of pure platinum.

14. The method of claim 11, wherein the step of depositing the thermal barrier coating comprises depositing the thermal barrier coating directly on top of the intermetallic coating.

15. The method of claim 11, wherein the step of diffusion heat treating comprises heating the substrate to a temperature in a range of from about 1093° C. to about 1177° C. for a time period in a range of from about 1 hour to about 4 hours.

16. A method of forming a coating system, the method comprising the steps of:
applying a layer of an additive material over a substrate, the additive material comprising a precious metal and the substrate comprising a nickel-based superalloy including, by weight, about 10.0% to about 10.5% cobalt, about 3.8% to about 4.2% chromium, about 1.8% to about 2.2% molybdenum, about 4.8% to about 5.2% tungsten, about 5.8% to about 6.2% rhenium, about 5.8% to about 6.2% tantalum, about 5.5% to about 5.8% aluminum, about 0.18% to about 0.50% hafnium, about 0.02% to about 0.03% carbon, about 0.1% to about 0.5% silicon, about 0.003% to about 0.005% boron, about 0.001% to about 0.0035% lanthanum, about 0.001% to about 0.0035% yttrium, about 3.8% to about 4.2% ruthenium, and a balance of nickel;
diffusion heat treating the substrate to form an intermetallic coating, the intermetallic coating comprising a γ-Ni phase and a γ′-Ni₃Al phase, each of the γ-Ni phase and the γ′-Ni₃Al phase alloyed with the additive material and one or more reactive elements from the substrate including hafnium, yttrium, chromium, and silicon; and
depositing a thermal barrier coating over of the intermetallic coating to form the coating system.

17. The method of claim 16, wherein the step of applying the layer of the additive material comprises plating the layer of the additive material directly onto the substrate.

18. The method of claim 16, wherein the additive material consists essentially of pure platinum.

19. The method of claim 16, wherein the step of depositing the thermal barrier coating comprises depositing the thermal barrier coating directly on top of the intermetallic coating

20. The method of claim 16, wherein the step of diffusion heat treating comprises heating the substrate to a temperature in a range of from about 1093° C. to about 1177° C. for a time period in a range of from about 1 hour to about 4 hours.
